(19) United States
(12) Patent Application Publication
(10) Pub. No.: US 2019/0278273 A1
(43) Pub. Date: Sep. 12, 2019

(54) ODOMETRY SYSTEM AND METHOD FOR TRACKING TRAFFIC LIGHTS

(71) Applicant: Robert Bosch GmbH, Stuttgart (DE)

(72) Inventors: Karsten Behrendt, Mountain View, CA (US); Mithun Jacob, Santa Clara, CA (US); Ryan Soussan, Palo Alto, CA (US); Libor Novak, Braskov (CZ)

(21) Appl. No.: 16/295,108

(22) Filed: Mar. 7, 2019

Related U.S. Application Data
(60) Provisional application No. 62/639,758, filed on Mar. 7, 2018.

(51) Int. Cl. G05D 1/02; G05D 1/00; B60W 10/04; B60W 50/00; G01C 21/26

(52) U.S. Cl. CPC G05D 1/021; G05D 1/0088; G01C 21/26; B60W 50/0097; B60W 10/04

(57) ABSTRACT

A method of operating an autonomous vehicle on a roadway includes generating stereo vision data with a stereo vision camera of a vehicle guidance system of the autonomous vehicle, the stereo vision data representative of a traffic light on the roadway, generating disparity map data with a controller of the vehicle guidance system based on the stereo vision data, and generating odometry data of the vehicle at a first time and at a second time after the first time with an odometry system of the autonomous vehicle. The method further includes determining a position of the traffic light based on the disparity map data at the first time, determining a predicted position of the traffic light in the disparity map data at the second time based on the odometry data, and determining a state of the traffic light at the predicted position.

This application claims the benefit of priority of U.S. provisional application Ser. No. 62/639,758, filed on Mar. 7, 2018 the disclosure of which is herein incorporated by reference in its entirety.

### FIELD

This disclosure relates to the field of vehicle guidance and, in particular, to vehicle computer vision systems for guiding a vehicle on a public roadway.

### BACKGROUND

Automated driving on highways is an actively-researched problem which has led to the emergence of many driver assistance systems. City street and residential street automated driving, however, provides a new set of challenges, which require more sophisticated algorithms in multiple areas ranging from perception, to behavioral planning, to collision avoidance systems. One crucial part of perception is the detection and classification of traffic lights and other roadway markers. Traffic lights present a challenging problem due to their small size and high ambiguity with other objects present in the urban environment, such as lamps, decorations, and reflections.

Previous works on traffic light detection and classification utilize spotlight detection and color thresholding, template matching, or map information. All these systems make strong assumptions. Usually, these previous systems require the traffic lights to be at least a certain size for the algorithm to work, on a distinctive background such as suspended traffic lights in front of the sky, or assume the existence of maps that contain prior knowledge about the locations of all traffic lights in the environment.

With recent advances and performance of deep neural networks, significant improvements have been made in several fields of machine learning and especially computer vision. Deep learning has been used for image classification, end-to-end object detection, pixel-precise object segmentation, and other applications. A drawback, however, of deep neural networks currently is the amount of training data used to train the network.

Accordingly, further developments in the area of using computer vision to identify roadway markers, such as traffic lights, are desirable.

### SUMMARY

According to an exemplary embodiment of the disclosure, a method of operating an autonomous vehicle on a roadway includes generating stereo vision data with a stereo vision camera of a vehicle guidance system of the autonomous vehicle, the stereo vision data representative of a traffic light on the roadway, generating disparity map data with a controller of the vehicle guidance system based on the stereo vision data, and generating odometry data of the vehicle at a first time and at a second time after the first time with an odometry system of the autonomous vehicle. The method further includes determining a position of the traffic light based on the disparity map data at the first time, determining a predicted position of the traffic light in the disparity map data at the second time based on the odometry data, determining a state of the traffic light at the predicted position and operating the autonomous vehicle based on the determined state of the traffic light.

According to another exemplary embodiment of the disclosure, a vehicle guidance system includes a stereo vision camera, an odometry system, and a controller. The stereo vision camera is configured generate stereo vision data representative of a traffic light. The odometry system is configured to generate odometry data of a corresponding vehicle at a first time and a second time after the first time. The controller is operably connected to the stereo vision camera and the odometry system The controller is configured to (i) generate disparity map data based on the stereo vision data, (ii) determine a position of the traffic light based on the disparity map data at the first time, (iii) determine a predicted position of the traffic light in the disparity map data at the second time based on the odometry data, (iv) determine a state of the traffic light at the predicted position, and (v) operate the vehicle based on the determined state of the traffic light.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a block diagram of a vehicle including a vehicle guidance system, as disclosed herein;

FIG. 2 is a block diagram of the vehicle of FIG. 1 at a first time and at a second time as well as two traffic lights;

FIG. 3 is a representation of disparity map data, bounding boxes around representations of the traffic lights of FIG. 2, and predicted positions of the traffic lights as generated and determined by the vehicle guidance system of FIG. 1;

FIG. 4 is a flowchart illustrating an exemplary method of operating the vehicle guidance system of FIG. 1; and

FIG. 5 is a block diagram illustrating a visualization of an update step performed by a tracking neural network of the vehicle guidance system.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

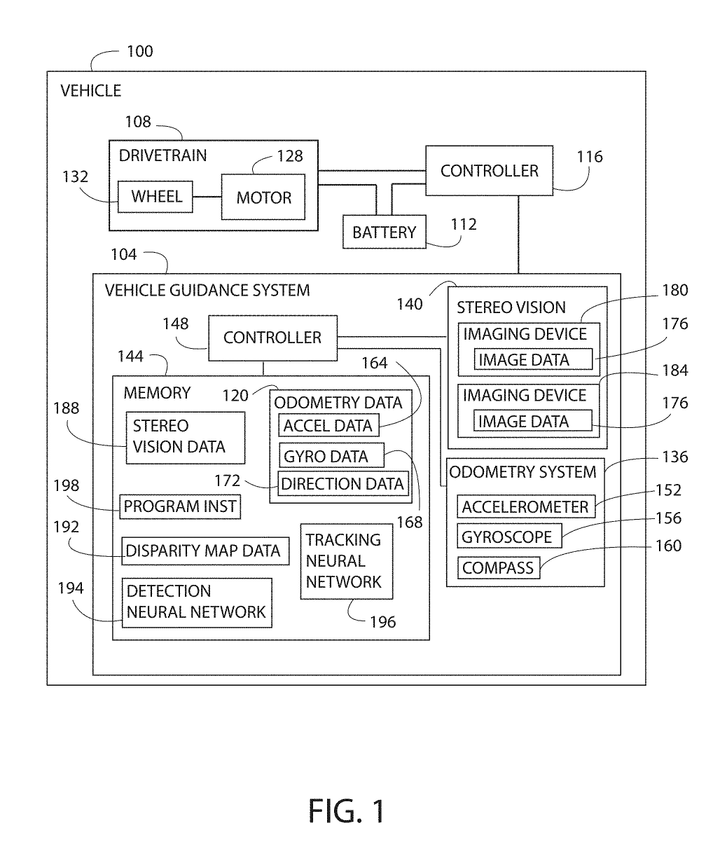

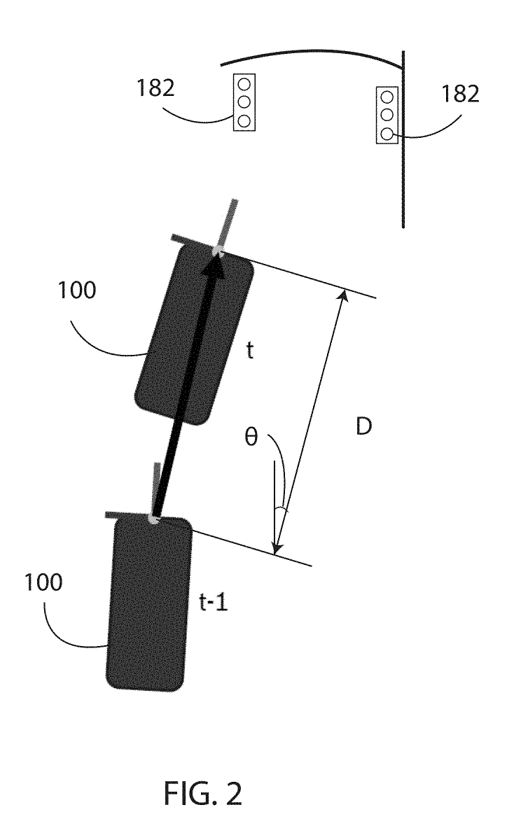

As shown in FIG. 1, a vehicle 100 includes a vehicle guidance system 104, a drivetrain 108, and a battery 112 each operably connected to a controller 116. The vehicle guidance system 104 is configured to use odometry data 120 to locate a position of a traffic light 182 (FIG. 2), for example, in real-time and with high accuracy. Reliable traffic light detection and classification is crucial for automated driving in urban environments. Currently, there are no systems that can reliably detect traffic lights 182 in real-time, without map-based information, and in sufficient distances needed for smooth urban driving. Each element of the vehicle 100 and the vehicle guidance system 104 is described below.

The drivetrain 108 of the vehicle 100 is configured to generate a force for moving the vehicle 100. In an exemplary embodiment, the drivetrain 108 includes an electric motor 128 operably connected to the battery 112 and to a wheel 132 or wheels of the vehicle 100. The rechargeable battery 112 supplies the electric motor 128 with electrical power for rotating an output shaft (not shown). Rotation of the output shaft of the electric motor 128 causes rotation of the wheel 132, which results in movement of the vehicle 100.

In one embodiment, the vehicle 100 is a fully autonomously-controlled vehicle, and the rotational speed of the electric motor 128 is determined automatically by vehicle guidance system 104. In another embodiment, the vehicle 100 is a semi-autonomous vehicle that is controlled in most conditions and environments by a human operator, but is controllable for emergency braking by the vehicle guidance system 104, based on a detected traffic light 182 for example. In a further embodiment, the vehicle 100 is fully operator controlled and includes driver assistance features, such as warnings when approach an intersection that is controlled with a traffic light 182, but that does not control or change a direction of travel of the vehicle 100.

In other embodiments, the motor 128 is an internal combustion engine (ICE) and/or the motor 128 includes an electric motor and an ICE that work together to rotate the wheel 132 as in a hybrid vehicle. Accordingly, the vehicle 100 is provided as any type of vehicle including an autonomous vehicle, an operator-controlled vehicle, an electric vehicle, an internal-combustion vehicle, and a hybrid vehicle.

The controller 116 of the vehicle 100 is configured to execute program instruction data in order to operate the drivetrain 108 and the vehicle guidance system 104, and to charge the battery 112. The controller 116 is provided as at least one microcontroller and/or microprocessor.

The vehicle guidance system 104 includes an odometry system 136, a stereo vision system 140, and a memory 144 each operably connected to a controller 148. The odometry system 136 includes motion sensors to generate the odometry data 120 that identifies a position of the vehicle 100 in 3D space over time. In an exemplary embodiment, the motion sensors of the odometry system 136 include at least one accelerometer 152, at least one gyroscope 156, and at least one compass 160. The accelerometer 152 is, for example, a microelectromechanical system (MEMS) accelerometer that is configured to generate acceleration data 164 corresponding to the acceleration of the vehicle 100 along at least one axis. The acceleration data 164 are stored in the memory 144 as part of the odometry data 120.

The gyroscope 156 is, for example, a MEMS gyroscope that is configured to generate gyroscope data 168 corresponding to a measured angular velocity of the vehicle 100 along at least one axis. The gyroscope data 168 are stored in the memory 144 as part of the odometry data 120.

The compass 160 is, for example, a MEMS compass that is configured to generate direction data 172 corresponding to changes in a magnetic field near the vehicle 100 along at least one axis. The direction data 172 are stored in the memory 144 as part of the odometry data 120.

Accordingly, the odometry system 136, in an exemplary embodiment, is provided by a nine-axis motion sensing device that senses acceleration in three axes, angular velocity in three axes, and changes in magnetic field in three axes. The odometry system 136 may also be provided as any other motion sensing device, and may also be referred to herein as an inertial measurement unit.

The stereo vision system 140 is configured to generate image data 176 from at least two vantage points. The stereo vision system 140 includes a first imaging device 180 and a second imaging device 184. Each imaging device 180, 184, which also referred to herein as a camera, a video camera, and a sensor, is configured to generate the image data 176 representative of an exterior area around the vehicle 100, such as in front of the vehicle 100 and in a driving direction of the vehicle 100. In an exemplary embodiment, the first imaging device 180 is mounted on a driver's side front portion of the vehicle 100, and the second imaging device 184 is mounted on a passenger's side front portion of the vehicle 100. In another embodiment, the imaging devices 180, 184 are located on the front of the vehicle 100 and are spaced apart from each other by eight to thirty centimeters, for example. Both of the imaging devices 180, 184 are configured to generate the image data 176 within a field of view extending from the front of the vehicle 100. Accordingly, the imaging devices 180, 184 generate the image data 176, which is representative of the traffic lights 182, road signs, and other roadway information items that the vehicle 100 approaches when the vehicle 100 travels in the forward driving direction. In an exemplary embodiment, the imaging devices 180, 184 are configured visible light cameras. In other embodiments, the imaging devices 180, 184 are configured as red, green, blue, and depth sensors (i.e. an “RGB-D sensor”), thermal cameras, and/or infrared cameras. The image data 176 are transmitted from the imaging devices 180, 184 to the controller 148 and are stored in the memory 144 as the stereo vision data 188.

The memory 144 is an electronic storage device that is configured to store at least the odometry data 120, the stereo image data 188, disparity map data 192, a detection neural network 194, and a tracking neural network 196, and program instruction data 198 for operating the vehicle guidance system 104. The memory 144 is also referred to herein as a non-transient computer readable medium.

The controller 148 of the vehicle guidance system 104 is configured to execute the program instruction data 198 in order to operate the vehicle guidance system 104. The controller 148 is provided as at least one microcontroller and/or microprocessor.

The odometry data 130 are representative of a position of the vehicle 100 at a particular time. As shown in FIG. 2, the vehicle 100 is shown in a first position at a first time (t−1) and a second position at a second time (t). The odometry data 130 include the change position of the vehicle 100 from the first time to the second time. For example, the odometry data 130 include the distance traveled (D) by the vehicle 100 and the angle (0) that the vehicle 100 has rotated. The odometry data 130, in other embodiments, include any other desired position information of the vehicle 100.

The stereo vision data 188 are generated by the controller 148 based on the image data 176 from the stereo vision system 140. The stereo vision data 188 include 3D information representative of the structures, features, and surroundings in front of the vehicle 100. For example, the stereo vision data 188 include information and data corresponding to traffic lights 182 that the vehicle 100 is approaching when the vehicle 100 is moving forward in a driving direction.

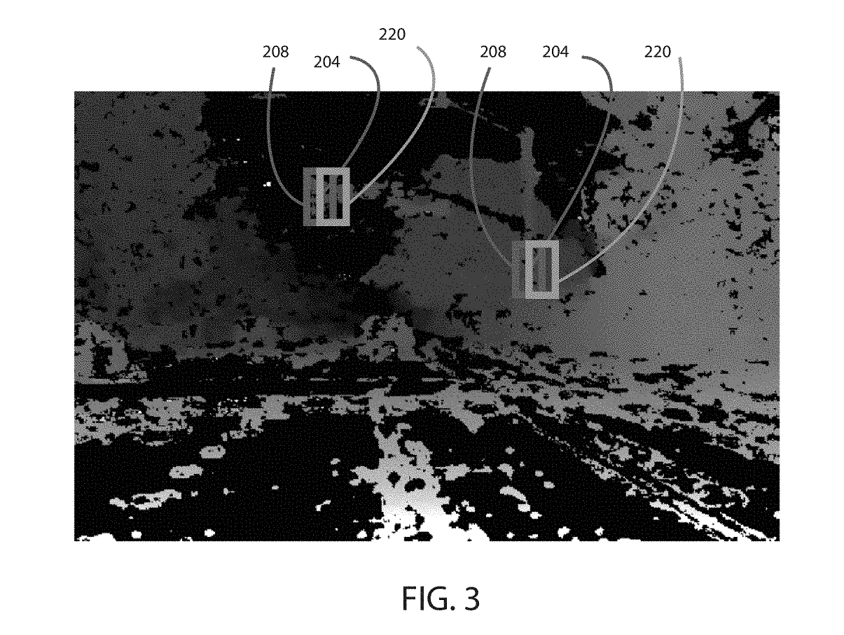

The disparity map data 192 are generated by the controller 148 based on the stereo vision data 188. A representation of the disparity map data 192 is shown in FIG. 3. The disparity map data 192, in one embodiment, is based on a comparison of the images of the stereo vision data 188 and includes relative depth information of the elements represented in the data 192. For example, as shown in FIG. 2, the vehicle 100 is approaching an intersection including two traffic lights 182. In the disparity map data 192 of FIG. 3, traffic light data 204 are outlined with bounding boxes 208 (as described herein). The disparity map data 192 corresponds to differences in the image data 176 from the first imaging device 180 and the second imaging device 184.

The detection neural network 194 is trained with many thousands of images of traffic lights. In one embodiment, the detection neural network 194 is an artificial convolutional neural network that is configured to receive an input of the image data 176 and to generate an output that identifies the location of the traffic lights 182. In locating the traffic lights 182, the detection neural network 194 places bounding boxes (not shown) at the position of the detected traffic lights 182 in the image data 176 and/or the disparity map data 192 and identifies a confidence factor that the traffic light 182 is actually located at the position of the bounding box.

The tracking neural network 196, in one embodiment, is also artificial convolutional neural network that is trained with many thousands of images of traffic lights and is configured to processes the disparity map data 192 and/or the image data 176 to locate the traffic light data 204 that are representative of the traffic lights 182. In locating the traffic light data 204, the tracking neural network 196 places one of the bounding boxes 208 at the position of the traffic light data 204 and identifies a confidence factor that the traffic light 182 is actually located at the position of the bounding box 208. The tracking neural network 196 typically generates an output faster than the detection neural network 194, and, in some embodiments, is configured to track traffic lights 182 that the detection neural network 196 may not have detected.

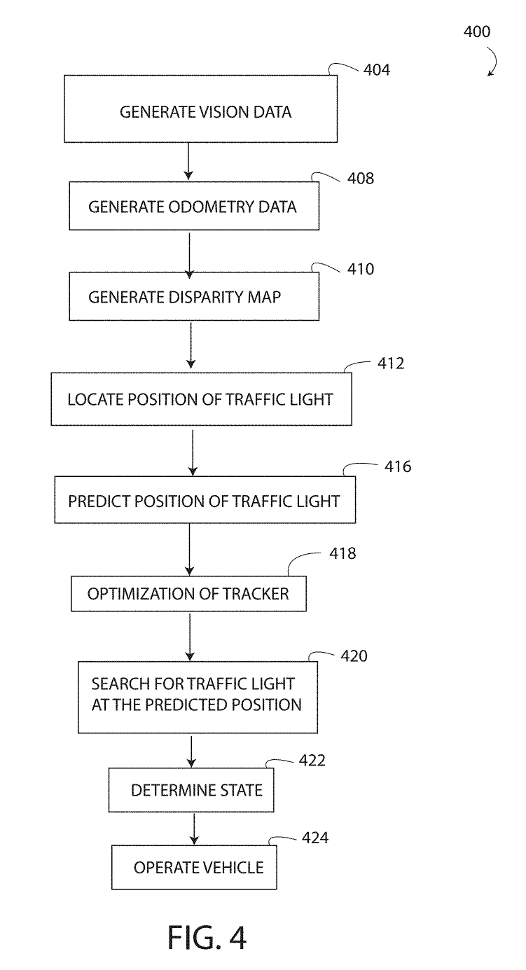

In operation, the vehicle guidance system 104 is configured to detect, to track, and to predict the position of traffic lights 182 based on the image data 176 and the odometry data 120. Specifically, the vehicle guidance system 104 uses the detection neural network 194 to detect the presence of traffic light(s) 182 in the image data 176. Then, the vehicle guidance system 104 uses the odometry data 120 to determine a motion estimate of the detected traffic lights 182, and uses the tracking neural network 196 to correct the aforementioned motion estimate, thereby resulting in a fast and accurate predicted position 220 (FIG. 3) of the traffic lights 182. The stereo vision data 188 is used to triangulate the position of the traffic light 182 in the 3D world, and the odometry data 120 is used to estimate movement of the traffic light 182 relative to the vehicle 100. Additional operational details are described with reference to the flowchart of FIG. 4 and the exemplary method 400.

As shown in FIG. 4 at block 404, the method 400 includes generating the image data 176 and the stereo vision data 188. The image data 176 is generated by each of the imaging devices 180, 184 as the vehicle 100 is moved in the driving direction. The stereo vision data 188 is generated by the stereo vision system 140 based on the image data 176. The vehicle 100 may be moved either autonomously or under the control of a human driver. At least the stereo vision data 188 is stored in the memory 144, and, in some embodiments, the image data 176 is also stored in the memory 144. In this example, the image data 176 and the stereo vision data 188 include traffic light data 204 that are representative of the traffic lights 182 on the roadway on which the vehicle 100 is operated.

Next at block 408 the method 400 includes generating the odometry data 120 with the odometry system 136. With reference to FIG. 2, the odometry data 120 is generated at the first time (t−1) and the second time (t), which is after the first time. Generating the odometry data 120 includes generating data corresponding to the position of the vehicle 100 in 3D space at the first time and generating data corresponding to the position of the vehicle 100 in 3D space at the second time. Additionally, the vehicle guidance system 104 determines a change in position of the vehicle 100 from the first time to the second time. The generated odometry data 120 is stored in the memory 144.

For example, the vehicle guidance system 104 determines that at time (t−1) the vehicle 100 is at a reference position of zero degrees rotation. Then, at time (t) the vehicle guidance system 104 determines that the vehicle 100 has rotated three degrees and has moved distance (D) of one meter. Thus, the vehicle guidance system 104 has determined two positions of the vehicle 100 and has also determined a change in position of the vehicle 100.

In block 410, the vehicle guidance system 104 generates the disparity map data 192 an example of which is represented in FIG. 3. From the disparity map data 192, as set forth herein, the vehicle guidance system 104 tracks the position in 3D space of the traffic lights 182. In some embodiments, this process is referred to as generating a motion model of the traffic lights 182.

In one embodiment, the vehicle guidance system 104 computes a disparity map for each video frame/image and each traffic light 182 is triangulated into a vehicle reference frame. The median of disparity values in the bounding box 208 is used to represent the entire traffic light data 204. This enables the vehicle guidance system 104 to better deal with noise in the disparity values. Next, the vehicle guidance system 104 uses linear triangulation to reconstruct the 3D coordinates of four corners of the bounding box 208 according to the following equation:

X̅*ₜ₋₁=[x^{c},y^{c},z^{c}]^{T}

in which c represents an identification of a corner. The linear triangulation is used in a previous vehicle reference frame (t−1) using the transformation from the camera frame to the vehicle reference frame. The vehicle guidance system 104 performs a transformation Tₜ₋₁^{t} between the vehicle reference frames for the time steps t−1 and t. Based on the transformation the following equations are derived:

X̅ₜ^{c}=Tₜ₋₁^{t}X̅ₜ₋₁^{c} (1)

x̅ₜ^{c}=PX̅ₜ^{c} (2)

where P is a projection matrix from the vehicle reference frame into the camera image frame, xₜ^{c} are the re-projected image coordinates of the c corner, and ⋅̅ represents the homogeneous coordinate notation. A bounding box estimate in the time step t is constructed from the four re-projected corners. This bounding box position is refined with the tracking neural network 196, as described below.

Next, at block 412, the vehicle guidance system 104 uses the detection neural network 194 to locate a traffic light in the image data 176, the stereo vision data 188, and/or the disparity map data 192. In an exemplary embodiment, frames or images of the image data 176 are processed for the presence of data corresponding to the traffic lights 182. For example, instead of taking a complete frame of the image data 176 as an input to the detection neural network 194, the detection neural network 194 receives only a subset of a frame/image of the image data 176, which may be referred to as a patch or a crop of the image data 176. In a specific embodiment, the each frame of the image data 176 includes three crops in an upper part of the frame because most traffic lights 182 are found in that area. This process increases the speed with which the detection neural network 194 is able to locate the traffic lights 182 in the image data 176.

At block 416 of the method 400, the vehicle guidance system 104 predicts the position of the traffic lights 182 (i.e. a predicted position 220 (FIG. 3)) in the disparity map data 192 at a second time (t) based on the odometry data 120. Since the traffic lights 182 are static objects in the environment, the vehicle guidance system 104 uses the stereo vision system 140 and the odometry system 136 to triangulate the predicted position of the traffic lights 182.

In a specific example, the vehicle guidance system 104 determines that at the first time that the left traffic light 182 is located ten meters from the vehicle 100 and has coordinates [25, 30] in the corresponding vector. According to the odometry data 120, the vehicle guidance system 104 determines that the vehicle 100 has moved one meter and has rotated three degrees. Accordingly, in predicting the position of the left traffic light 182 in the disparity map data 192 at the second time (t), the vehicle guidance system 104 determines that the traffic light is nine meters from the vehicle 100 and has coordinates [32, 31], which have been updated using triangulation based on the determined angle (0) and distance (D) moved by the vehicle 100. The coordinates [32, 31] therefore represent a predicted position of the left traffic light 182 in the disparity map data 192 at the second time (t) as represented by the left bounding box 220. The process is used to determine the position of the right traffic light 182 as represented in the disparity map data 192 by the right bounding box 220.

Next, in block 418 of the method 400, the position of the bounding block 208 that identifies the position of the traffic light data 204 is refined using the tracking neural network 196. The vehicle guidance system 104 tracks traffic light data 204 as small as three to four pixels in width. The dark pattern of the traffic light data 204, however, may not yield too many feature points, especially if in front of unlit buildings or if there are trees in the background. In addition to that, traffic lights 182 flicker with a frequency given by the difference between a frame rate of the stereo vision system 188 and the traffic light 182 refresh rate. Also, the state of the traffic light 182 may change during the time of tracking, such as changing from red to green or from green to red, for example.

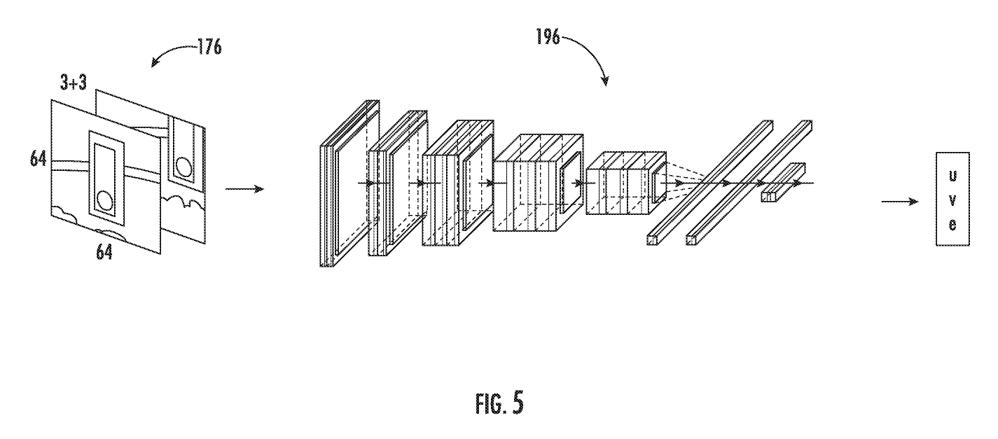

The optimization approach of block 418 is applied in order to prevent divergence of the tracking neural network 196. Specifically, in order to deal with these conditions and with reference to FIG. 5, the tracking neural network 196 is trained to estimate the misplacement of the traffic light 182 from a prototype image. In particular, the tracking neural network 196 takes a prototype and a candidate bounding box 208 estimated by the above-described motion model. The tracking neural network 196 expands and rescales the prototype and the candidate bounding box 208 so that the traffic light data 204 are of the reference width of approximately twenty pixels and the whole crop is approximately 64×64 pixels. All three channels are taken from both images and combined to a 6×64×64 tensor. The output is a 3-element vector [u, v, e] where u and v are the coordinates of the traffic light data 204 in the candidate image and e is the estimated error of the coordinate estimate. The error estimate e represents the uncertainty of the position estimate and is used to trigger the update of the prototype image. According to this approach, the method 400 identifies small areas of traffic light data 204 of widths from three to six pixels, for example. Additionally, the tracking neural network 196 may be trained to overcome changes in illumination, noise, partial occlusion, and also changing traffic light 182 states. Thus, in block 418 the vehicle guidance system 104 optimizes a predicted position of the traffic light 182 based at least on the disparity map data 192 at the first time (t−1). This approach prevents divergence and increases the invariance of the tracking neural network 196.

At block 420 of the method 400, the vehicle guidance system 104 searches the image data 176 for data 176 representative of the traffic light 182 at the predicted positions from block 416 of the method 400. The bounding boxes 220 (i.e. the predicted positions) of the traffic lights 182 enable the vehicle guidance system 104 to process quickly the image data 176 and the disparity map data 192 and to locate accurately the position of the traffic lights 182 in real time as the vehicle 100 moves on the roadway at speeds of up to one hundred kilometers per hour. Specifically, the predicted positions focus the vehicle guidance system 104 on the areas of the image data 176 that are the most likely to include the traffic light data 204 representative of the traffic lights 182 at the second time.

Next, at block 422 vehicle guidance system 104 determines the state of the traffic lights 182 at the predicted positions as being, red, yellow, or green, for example. The state of the traffic lights 182 is stored in the memory 144, and the vehicle guidance system 104 guides the vehicle 100 based on the determined state of the traffic lights 182.

At block 424 of the method 400 the vehicle 100 is operated and, in one embodiment, the vehicle 100 is fully autonomous and the vehicle guidance system 104 causes the vehicle 100 to come a complete stop at an intersection when it is detected that the state of the traffic lights 182 is red. In another example, the vehicle guidance system 104 causes the vehicle 100 to proceed through an intersection when it is determined that the state of the traffic lights 182 is green. In this way, the autonomous vehicle 100 is operated based on the determined state of the traffic lights 182.

In one specific embodiment, the states of all detected traffic lights 182 in the disparity map data 192 are determined with a small classification network that differentiates between the different traffic light states and additionally removes false positives. The bounding boxes 208, 220 are expanded and rescaled so that the traffic light data 204 are twenty pixels wide and the whole crop is 64×64 pixels. This provides approximately twenty-two pixels of context on the left and right. The extra margin gives regional context which is used for classification. Without the additional context, for example, traffic light poles or parts of cars (in case of false positives) would not be taken into account.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method of operating an autonomous vehicle on a roadway, comprising:
generating stereo vision data with a stereo vision camera of a vehicle guidance system of the autonomous vehicle, the stereo vision data representative of a traffic light on the roadway;
generating disparity map data with a controller of the vehicle guidance system based on the stereo vision data;
generating odometry data of the vehicle at a first time and at a second time after the first time with an odometry system of the autonomous vehicle;
determining a position of the traffic light based on the disparity map data at the first time;
determining a predicted position of the traffic light in the disparity map data at the second time based on the odometry data;
determining a state of the traffic light at the predicted position; and
operating the autonomous vehicle based on the determined state of the traffic light.

2. The method as claimed in claim 1, wherein:
the odometry system includes at least one accelerometer and at least one gyroscope; and
generating the odometry data includes generating acceleration data with the at least one accelerometer and generating gyroscope data with the at least one gyroscope.

3. The method as claimed in claim 2, wherein determining the predicted position comprises:
determining the predicted position in 3D space based on the acceleration data, the gyroscope data, and the disparity map data.

4. The method as claimed in claim 1, wherein determining the odometry data comprises:
determining a position of the vehicle in 3D space at the first time, and
determining the position of the vehicle in 3D space at the second time.

5. The method as claimed in claim 4, further comprising determining a change in position of the vehicle from the first time to the second time based on the odometry data.

6. The method as claimed in claim 1, further comprising:
searching the disparity map data at the predicted position for a representation of the traffic light.

7. The method as claimed in claim 1, wherein the stereo vision camera includes at least a first imaging device and a second imaging device.

8. The method as claimed in claim 7, wherein the disparity map data corresponds to differences in image data from the first imaging device and the second imaging device.

9. A vehicle guidance system, comprising:
a stereo vision camera configured generate stereo vision data representative of a traffic light;
an odometry system configured to generate odometry data of a corresponding vehicle at a first time and a second time after the first time; and
a controller operably connected to the stereo vision camera and the odometry system, the controller configured to (i) generate disparity map data based on the stereo vision data, (ii) determine a position of the traffic light based on the disparity map data at the first time, (iii) determine a predicted position of the traffic light in the disparity map data at the second time based on the odometry data, (iv) determine a state of the traffic light at the predicted position, and (v) operate the vehicle based on the determined state of the traffic light.

10. The vehicle guidance system as claimed in claim 9, wherein the odometry system comprises:
at least one accelerometer configured to generate acceleration data; and
at least one gyroscope configured to generate gyroscope data.

11. The vehicle guidance system as claimed in claim 10, wherein the controller is further configured to determine the predicted position in 3D space based on the acceleration data, the gyroscope data, and the disparity map data.

12. The vehicle guidance system as claimed in claim 9, wherein the odometry data includes a first position of the vehicle in 3D space at the first time, and a second position of the vehicle in 3D space at the second time.

13. The vehicle guidance system as claimed in claim 12, wherein the controller is further configured to determine a change in position of the vehicle from the first time to the second time based on the odometry data.

14. The vehicle guidance system as claimed in claim 13, wherein the controller is further configured to search the disparity map data at the predicted position for a representation of the traffic light.

15. The vehicle guidance system as claimed in claim 9, wherein the stereo vision camera comprises:
at least a first imaging device operably connected to the controller; and
at least a second imaging device operably connected to the controller.

16. The vehicle guidance system as claimed in claim 15, wherein the disparity map data corresponds to differences in image data from the first imaging device and the second imaging device.
